(19) United States
(12) Patent Application Publication
(10) Pub. No.: US 2017/0319313 A1
(43) Pub. Date: Nov. 9, 2017

(54) BITE REGISTRATION TOOL, BITE REGISTRATION TOOL SET, AND SUITABLE BITE REGISTRATION METHOD

(71) Applicant: Merz Dental GmbH, Luetjenburg (DE)

(72) Inventor: Peter Boehmert, Hoegsdorf (DE)

(21) Appl. No.: 15/528,873

(22) PCT Filed: Nov. 23, 2015
(86) PCT No.: PCT/EP2015/077396

§ 371 Date: May 23, 2017

(30) Foreign Application Priority Data
Nov. 25, 2014 (DE) 10 2014 117 252.3

(51) Int. Cl. A61C 19/05; A61C 9/00; A61C 13/34

(52) U.S. Cl. CPC A61C 19/05; A61C 13/34; A61C 9/0006; A61C 9/0053

(57) ABSTRACT

A bite registration tool includes tooth casts (UZF and OZF) that are placed on top of one another in the occlusal position, and a bite registration tool set includes at least one bite registration tool for the upper and lower jaws (OKB and UKB) and a molding material. A bite registration method, especially for a full prosthesis, uses the bite registration tool and tool set.

The present invention relates to a bite registration tool, a bite registration tool set, and a suitable bite registration method.

As is known, special recording devices, which are each produced individually and manually, are used for bite registration. With the aid of these recording devices, the jaws of the patient are brought into an occlusal position, so that this information can be transferred for further processing in an articulator.

For this purpose, impression trays conventionally designed for taking impressions of the upper jaw and lower jaw are used to receive impression materials of all kinds. With these impression trays for the upper jaw and lower jaw, a preliminary plastic impression of the edentulous jaws is prepared. These preliminary impressions are cast with plaster, such that planning models are obtained which allow the dental technician to create a preliminary bite registration from thermoplastic or other materials and wax rims. Moreover, for the precise impressions, very strongly individualized jaw registration devices made of plastic have to be produced (functional trays), with which the dentist makes functional impressions that reflect the mucodynamic processes of the soft tissue and fixes the position of the functional margin of the later prosthesis. These very precise impressions are in turn cast with plaster and processed to give the master model. Thereafter, the master models of the upper jaw and lower jaw are fitted with the preliminary bite registration device into the articulator, wherein the preliminary bite registration serves exclusively to determine the vertical height between upper jaw and lower jaw.

Bite plates made of plastic, which allow the dentist to determine the correct horizontal hinge axis of the jaw, are now formed on the master models. This bite registration is then set up in an articulator.

Generally, a particular disadvantage of the abovementioned steps is that, after the preliminary impression and functional impression have been taken by the dentist, the dental technician is called upon to finally create the prosthesis base, which forms the basis for the dentist to carry out the bite registration, in order then once again for the dental technician to carry out a model analysis by means of the articulator for the purpose of creating a model using wax rims, which model then once again has to be adapted by the dentist. Should corrections prove necessary, the dentist has to contact the dental technician again, in order for the prosthesis to be finalized in the end by the dental technician, which prosthesis is in turn then finally fitted in the patient by the dentist. This is the known and complex procedure by which a partial or total prosthesis is created, and which necessitates multiple exchanges between dentist and dental technician.

Instead of the known methods of taking plastic impressions, i.e. analog methods, digital approaches have recently been followed for generating the required master models. Intraoral scanners or I-trays have been very promising approaches which make the taking of impressions with the aid of a conventional impression tray system completely superfluous. The virtual master models thus generated can be implemented immediately in software and have to be brought into connection with a bite registration as described above. This procedure can be carried out by analog means, by initially printing or milling the models and subsequently bringing them together with the registration in the analog articulator. However, a digital approach is also possible in which the virtual models are directly cast in virtually with the likewise scanned-in surfaces of the jaw registration, so-called matching.

In principle, dentistry requires a safe, validated route for optimal jaw registration in order to determine the vertical height and the horizontal hinge axis of the temporomandibular joint. This very crucial step, involving taking an impression of the two jaws and detecting the correct relationship of both jaws with respect to one another, is of the utmost importance to the success, for example, of work on a total prosthesis.

The object of the present invention is therefore to overcome the abovementioned disadvantages. Moreover, it is an object of the present invention to permit a high degree of precision as regards the relationship of upper jaw and lower jaw after an impression has been taken of the upper jaw and lower jaw with respect to one another. Moreover, it is a further object of the present invention to be able to directly check the function of the subsequent prosthesis.

These objects are achieved by the features of claim 1, 2 or 3, by the bite registration tool set according to claim 8, and by the bite registration method according to claim 12.

According to the application, a bite registration tool is made available which consists of tooth casts lined up in the occlusal position. With this measure, the advantage achieved is that the testing-out can be performed in situ at the dentist's and, in agreement with the patient, the prosthesis can be suitably oriented in cooperation with a likewise preferably same-shape tooth cast of a total prosthesis, which is produced from industrially produced milling blocks with tooth casts likewise lined up in the occlusal position. In this way, the individual bite situation, which can be fixed in advance and adapted by virtue of the industrial production of these milling blocks, can already be provided for the patient before the prosthesis is finished. However, it is likewise evident that the bite registration tool according to the application can also be used in an individual manual set-up of rows of teeth of the partial and total prostheses in the classical sense. If the bite registration tool both for the upper jaw and also for the lower jaw is produced with tooth casts lined up in the occlusal position and is used for the bite registration, it is possible, after fitting and after the dentist has checked the esthetics with respect to the upper jaw, for the bite registration tool also to be fitted precisely in place onto the lower jaw via the impression compound, thus allowing bite registration to be carried out in situ at the dentist's, preferably in an analog procedure. Therefore, according to the application, a partial or total prosthesis already adapted to the upper jaw is used in a simple manner and used with the lower-jaw bite registration tool for the bite registration. In this case too, the dentist can carry out the corresponding esthetics check with the patient at one visit, before the corresponding prosthesis for the lower jaw is produced and adapted.

The bite registration zone designates the area which ultimately defines the bite registration. Hitherto, the bite registration zone was arranged in the occlusal plane, wherein according to the application, with the bite registration zone for the lower jaw now shifted below the occlusal plane, the advantage is achieved that the bite registration can be performed more flexibly with the bite registration tool according to the application, since in particular with the shift of the bite registration zone to outside of the occlusal plane, or below the occlusal plane, for the lower jaw, the bite registration zone is shifted to a flexibly configured impression area. In other words, the bite registration tool can thus be introduced in the occlusal position into the oral cavity of the patient, wherein the adaptation of the bite registration is carried out in a separate bite registration zone before this.

With the bite registration tool according to claim 3 of the application and thus the provision of a receiving area for the jaw, the dentist is in turn able, together with the patient, to carry out an esthetics check in conjunction with a bite registration and, before calling upon the dental technician, can agree with the patient on the esthetics of the partial or total prosthesis that is later to be produced with the patient.

According to the application, therefore, it is possible to dispense with the use of an articulator, and the agreement between dentist and dental technician is limited to the essential. Ideally, bifunctional impression-taking is performed by the dentist, i.e. at an initial visit to the dentist, who then asks the dental technician to produce the finished partial or total prosthesis ready to be tested out on the patient, i.e. only a second and final visit to the dentist is needed.

Further advantageous embodiments of the present invention are the subject matter of the dependent claims.

If, in accordance with claim 4, a coding element is provided on the bite registration tool, the congruent surfaces of the upper jaw and lower jaw can be transferred via the coding element, for example if necessary into an articulator. If the coding element is in particular arranged orally, the bite registration method according to the application can be carried unproblematically and without disruption. If the coding element is advantageously designed to be broken up and/or to be removable, this permits more flexible handling both for the dentist in situ and also for the dental technician. If the coding element has a multi-part design, the adaptation of the bite registration can be made more flexible. In the case of a form-fit engagement, account can be taken of hygiene requirements.

If a pre-formed palate region is advantageously provided in the bite registration tool for the upper jaw, the oral fitting of the bite registration tool for the upper jaw is improved since, by filling with impression material, a suction effect is obtained for the bite registration tool, and it therefore remains exactly in the previously determined position.

It has proven particularly advantageous if in principle sterilizable plastics are used as material for the bite registration tools, preferably PEEK or similar material. Generally, it would also be conceivable to use metal as material for bite registration tools, but the method of producing these is unnecessarily more cost-intensive.

If a bite registration tool set is in principle made available which an upper-jaw bite registration tool, a lower-jaw bite registration tool, and an impression compound either produced based on silicone or having reversible and/or thermoplastic properties, the advantage achieved is that the dentist has available all the bite registration instruments needed for the treatment, with which instruments he can bring together all the relevant information and data, for example by analog means, so as to be able to have a partial or total prosthesis produced by the dental technician.

To be able to take account of the different oral conditions presented by the patient, and to keep the corresponding bite registration tool sets to be stored by the dentist to a reasonable number, it has proven advantageous for the bite registration tools to be made available preferably in four sizes, specifically S, M, L and XL.

It has likewise proven advantageous if the bite registration tool set likewise contains a bite fork with connection element, such that referencing via the connection element and the coding element is fixed with the bite registration tool. With this advantageous development, dental instruments which are needed for optimal bite registration are thus also available to the dentist.

Further advantageous developments are the subject matter of the further dependent claims.

In terms of methodology, the release of the connection via the coding element of the bite registration tool permits simple handling for the dentist, with which the dentist can check the esthetics and also carry out positioning. If, for example, the esthetics check gives a negative result, the dentist has no problem in repeating the bite registration and/or bite registrations and, if appropriate, achieving a more positive result.

For the production of the partial or total prosthesis, the bite registration tools encoded via the coding element can then be positioned in a dental scanner along with jaw areas of which an impression has been taken using the impression compound, in order to generate a digital data record for the bite registration. With this digital data record, the prosthesis base of a partial or total prosthesis can then easily and optimally be milled or produced by means of a milling block, preferably a dental milling block, which likewise has the tooth casts lined up in the occlusal position and are in accordance with the tooth casts of the bite registration tool.

It is therefore clear that, with the bite registration tool set according to the application having a lower-jaw bite registration tool which preferably has a bite registration zone into which an impression compound is introduced between lower jaw and bite registration tool, the treating dentist is provided with a complete means, which is simplified compared to the previously known bite registration method and which allows a bite registration which, in the event of incorrect positioning or unsatisfactory esthetics, can be directly corrected both by the dentist and by the patient at one visit. The previous methods hitherto allowed the esthetic result to be checked no earlier than the time of the first testing-out after production by the dental technician.

By virtue of the respective design of the bite registration tool, it is also possible, using a silicone-containing and/or reversible and/or thermoplastic impression compound, to carry out the bite registration or positional fixing quite effortlessly and without stress.

It is emphasized that “tooth casts” are to be understood as meaning any spatial arrangement that is able to provide an occlusal position, for example likewise artificially produced teeth.

The advantageous embodiment of the present invention is represented on the basis of the following drawings.

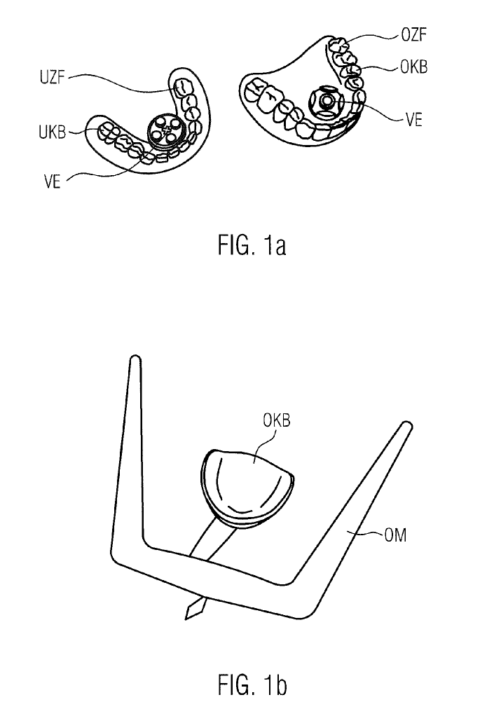

FIG. 1a shows the bite registration tool according to the application both for the upper jaw and for the lower jaw.

FIG. 1b shows the bite registration tool according to the application for the upper jaw and a bite fork.

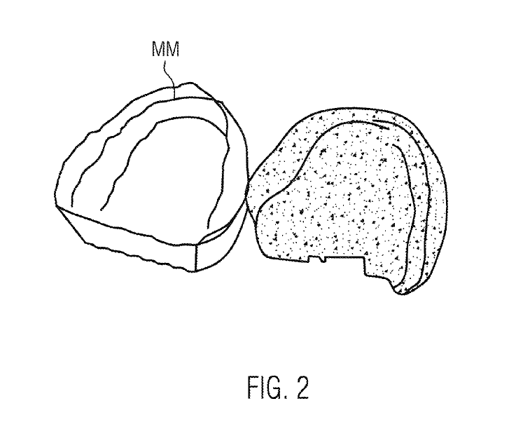

FIG. 2 shows the congruent surfaces which result from the master model, and the negative surface geometry of the partial impression from the upper-jaw bite registration tool.

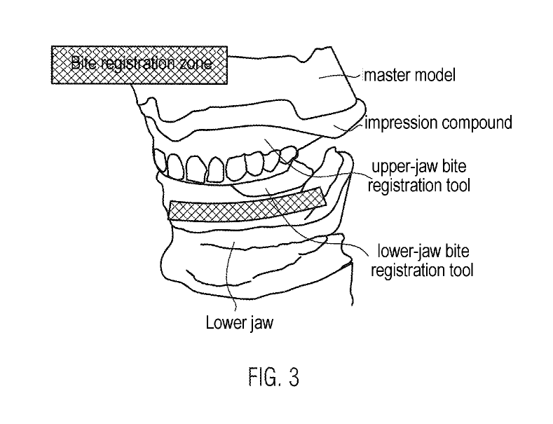

FIG. 3 shows the bite registration tools according to the application for the upper jaw and lower jaw, which bite registration tools are represented in each case by impression compounds with the master models for upper jaw and lower jaw.

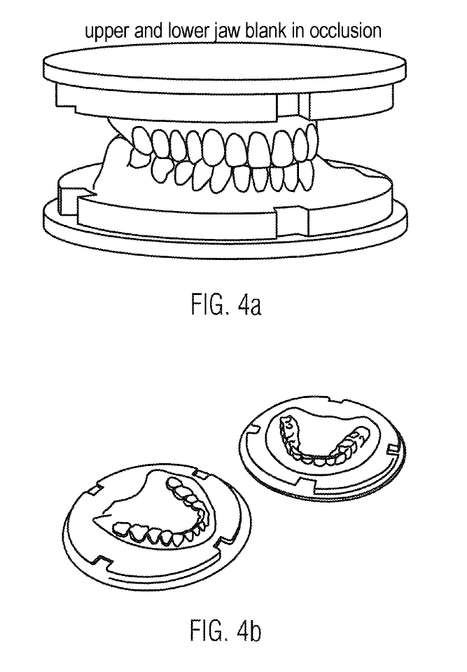

FIGS. 4a and 4b show the milling blocks for the upper jaw and lower jaw, which are in direct reference to the bite registration tool via the rows of teeth.

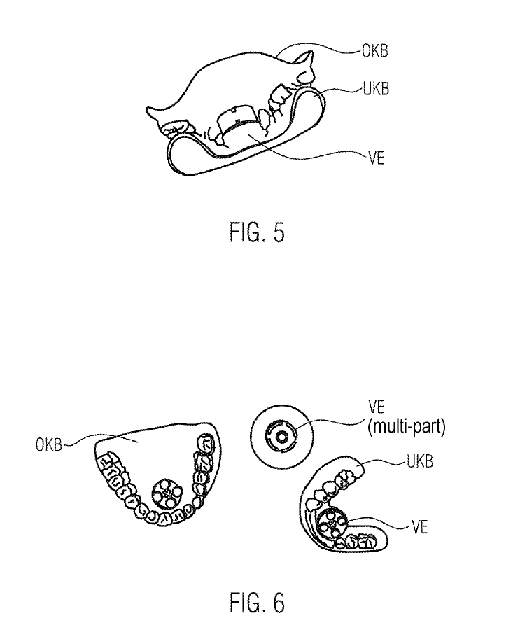

FIG. 5 shows the bite registration tool according to the application shown in FIG. 1 for the upper jaw and lower jaw, which are encoded via the coding element.

FIG. 6 shows the bite registration tool according to the application shown in FIG. 1 for the upper jaw and lower jaw, with a multi-part coding element.

FIG. 1 shows the upper-jaw bite registration tool OKB and the lower-jaw bite registration tool UKB, which each have a lower-jaw tooth cast UZF and upper-jaw tooth cast OZF lined up in the occlusal position. In this embodiment, a coding element VE is also shown via which the bite registration is encoded. In this embodiment, the coding element VE is designed with the possibility of being plugged into both the lower-jaw bite registration tool UKB and the upper-jaw bite registration tool OKB, preferably with form-fit engagement, and integrated in the bite registration tools, i.e. the coding element is made of the same material as the bite registration tools. However, it will be noted at this point that the coding elements are also designed as magnets which have been embedded in the bite registration tools in accordance with dental specifications.

It is clear from FIG. 1a that the upper-jaw bite registration tool OKB, when turned upside down, can be placed onto the lower-jaw bite registration tool UKB and joined together, and the respective tooth casts are lined up such that an occlusal position can be obtained. When the upper-jaw bite registration tool OKB has been turned upside down and joined to the lower-jaw bite registration tool UKB, both bite registration tools can be encoded via the coding elements designed as a plug connection.

FIG. 1b shows a bite fork OM, preferably an ala-tragus line finder, which has a connection element. The connection element is designed such that it is connected to the coding element of the upper-jaw bite registration tool OKB, preferably with force-fit engagement, so that the upper jaw bite registration tool OKB, with the bite fork OM connected thereto, can be oriented in the oral cavity of the patient.

FIG. 2 shows, by way of example for the upper jaw, the positive surface geometry of the master model MM which, for example, can be scanned in digitally and/or is generated by means of analog impression-taking. In addition, FIG. 2 shows the negative geometry of the partial impression from the upper-jaw bite registration tool, which was produced by means of the impression compound that is arranged between the upper-jaw bite registration tool OKB and the alveolar ridge region. In a further digital process, these two impressions can be assigned in terms of surface area by matching. It will be seen from the view in FIG. 2 that the corresponding assignment between bite registration tool and alveolar ridge region is made available by means of a silicone-containing and/or a reversible and/or thermoplastic impression compound, by means of which both the horizontal and vertical positioning takes place. The bite registration thus takes place in a simple analog procedure.

FIG. 3 shows an example of the arrangement by which the bite registration tools both of the upper jaw and of the lower jaw is joined via impression compounds to the master models for upper jaw and lower jaw. It will be seen in particular from this view that ultimately the corresponding bite registration zone is present below the tooth casts lined up in the occlusal position, and specifically on the moving lower jaw. The simplicity of the bite registration method is particularly clear from this and is achieved in particular by the tooth casts lined up in the occlusal position and also by a bite registration zone which, unusually for the lower jaw, lies below the occlusal plane, wherein the bite registration tools have receiving areas for the jaw. For example, after the upper-jaw bite registration tool OKB has been introduced and positioned in the oral cavity of the patient via a silicone-containing and/or reversible and/or thermoplastic impression compound and, if appropriate, the impression compound has been given time to harden, the lower-jaw bite registration tool UKB is then likewise introduced into the oral cavity of the patient via the impression compound, after the coding by the coding element. On the basis of the coding and of the tooth casts lined up in the occlusal position, the tooth casts of the upper jaw bite registration tool OKB are then brought into the occlusal position with the tooth casts of the lower-jaw bite registration tool UKB and a bite registration is carried out, as a result of which a bite registration zone is generated between the lower jaw and the lower-jaw bite registration tool, which zone lies below the occlusal plane of the lined up tooth cast of the lower jaw. By means of the plastic impression compound located between the lower jaw and the lower-jaw bite registration tool UKB, a bite registration zone is thus generated which is located below the occlusal plane of the tooth casts for the lower jaw. After the respective impression compounds have hardened, and after the coding element has been released, it is possible for the dentist, together with the patient, to check the esthetic result in order to establish whether the overall esthetic appearance is optimal in terms of the length of the front teeth, the shape of the teeth generally, the laugh line, the cuspid line, Camper's plane and the midline relative to the center of the face. At the end of this first process of the bite registration and of the jaw registration, the patient can therefore already experience and examine the spatial conditions of the total prosthesis in this first visit. If these esthetic parameters are correct, the function can then be checked by means of the upper-jaw bite registration tool being brought with the lower-jaw bite registration tool into the terminal occlusal position that the patient finds comfortable, without encoding and by the patient closing his or her mouth. Through the closing of the mouth, the production of a partial or total prosthesis can then be carried out via the tooth casts of a milling block that are lined up in the same occlusal position and on the basis of the further information, present in complete form, concerning the spatial arrangement in the oral cavity of the patient. As a result of this conventional bite registration, an interface between dental practice and laboratory is created which, in terms of simplicity and precision, has not hitherto been achievable. An advantageous testing-out of this kind carried out at the dentist's is made possible by the upper-jaw bite registration tool OBK and lower-jaw bite registration tool UKB which have the tooth casts already lined up in the occlusal position, wherein the tooth casts lined up in the occlusal position are each assigned to a corresponding milling block for upper jaw and lower jaw, which milling block contains the same or similar teeth lined up in the occlusal position.

A milling block of this kind for the upper jaw and lower jaw is shown for example in occlusion in FIG. 4a, wherein the respective milling blocks for upper jaw and lower jaw in occlusion is reproduced without coding in FIG. 4b. It will be seen from this view which function the coding element assumes in particular during the bite registration, since an assignment between upper jaw and lower jaw takes place in the unfitted state which in each case fixes, both vertically and horizontally, the spatial conditions for the total prosthesis for the upper jaw and also for the lower jaw. On the basis of the coding element, it is thus ensured that the spatial machining of the respective prosthesis base of the milling blocks is brought into mutual relationship and, by way of the build-up consisting of impression compound for the lower jaw, lower-jaw bite registration tool UKB, upper-jaw bite registration tool OKB and impression compound for the upper jaw, a complete positional fixing and spatial positioning is permitted for the respective total prosthesis.

FIG. 5 shows the upper-jaw bite registration tool OKB and the lower-jaw bite registration tool UKB coded via the coding element VE. The respective tooth casts of the bite registration tool for the upper jaw OKB and the lower jaw UKB rest on each other in the occlusal position and are in bearing contact.

The bite registration tools with impression compound, which are encoded via the coding element, are then positioned in a digital scanner in order thereby to be able to generate a digital data record for the bite registration, as a result of which, via the tooth casts lined up in the occlusal position both in the bite registration tools and also in the milling block after creation of the digital data record, the prosthesis base of the dental milling block can then be machined such that the dental technician can also produce a complete prosthesis in just one work step by milling, preferably digital milling. Further work by the dental technician is also unnecessary or unlikely since the required check on the esthetics for obtaining important information on the midline, the pupillary plane, the occlusal plane and the length of the front teeth has already been carried out, so that the dental technician can precisely implement the positional fixing and the bite registration in the software. It is likewise advantageous if, by way of the master models, preferably virtual master models according to the application, and by way of the negative surfaces, preferably virtual negative surfaces according to the application, of the impression compounds, the encoded bite registration tool can be matched via the congruent surfaces in order thereby to precisely define the interalveolar space. Moreover, in the further step, the surfaces of the vestibular scan of the upper-jaw bite registration tool are assigned to the surface of the row of teeth of the upper-jaw milling block that are likewise congruent.

FIG. 6 shows the upper-jaw bite registration tool OKB and the lower-jaw bite registration tool UKB encoded, wherein a multi-part coding element is clearly shown via which, for example, the vertical orientation of the upper-jaw bite registration tool OKB and of the lower-jaw bite registration tool UKB is mutually adjustable. It will also be seen that, via this multi-part coding element in the form of a plug-in connection which is constructed one on top of another, both the esthetics check and also the testing can be carried out in a simple manner when one of these multi-part coding elements has been removed. These technical and digital links are all based on information obtained by analog means via the bite registration tools, since, with the aid of diverse impression materials in the form of impression compounds introduced into the receiving area provided in the bite registration tools for the jaw, it is possible to adjust the physiological occlusal plane, the length of the front teeth, the shape of the teeth in general, the laugh line, the cuspid line, the midline in relation to the face, and an overall esthetic impression. As an aid, it is possible to use a bite fork, for example in the form of a reference arch, which is aligned with Camper's plane and permits a reference to the pupillary plane.

It is once again emphasized that, with the bite registration tools according to the application, both the dentist and also the patient can fix and test out all the parameters that make up a functioning prosthesis, thereby validating the bite registration or jaw relationship. If the result does not meet the expectations in this respect, the treatment provider or dentist can repeat the bite registration itself and then carry out a further verification, until the patient and the dentist arrive at a final and tested result. This is also associated with an enormous saving in material, since only the hardened impression compound has to be renewed or supplemented. After the esthetics have been checked, the two bite registration tools for upper jaw and lower jaw are then encoded in order to carry out the corresponding function check. If the bite registration tools for upper jaw and lower jaw are then encoded again, the entire complex can then be scanned in and matched via the alveolar ridge region, and the data thus obtained can be used for the machining of the prosthesis base of a milling block which, along with the tooth casts of the bite registration tools, makes available identical or similar tooth casts.

It has proven advantageous if the tooth casts lined up in the occlusal position correspond at least partially to the tooth casts of a milling block, preferably of a dental milling block, which are likewise lined up in the occlusal position, as is described in the German patent application DE102011118320.9, the complete disclosure of which is incorporated into the present disclosure, preferably with a view to the milling block, the milling block system and corresponding production methods.

1. A bite registration tool, comprising: a pair of tooth casts lined up in the occlusal position.

2. A bite registration tool, comprising a bite registration zone for the lower jaw, below an occlusal plane thereof.

3. A bite registration tool, comprising: a receiving area for the jaw.

4. The bite registration tool of claim 1, further comprising a coding element arranged orally formed by a plug connection.

5. The bite registration tool of claim 4, wherein a pre-formed palate region is provided in the upper-jaw bite registration tool.

6. The bite registration tool of claim 1, wherein the bite registration tool is formed from PEEK or other sterilizable plastics.

7. The bite registration tool of claim 1, wherein the tooth casts each corresponds to a complete row of teeth for a total prosthesis.

8. A bite registration tool set, comprising: at least one upper-jaw bite registration tool and one lower-jaw bite registration tool as claimed in claim 1, wherein an impression compound is provided.

9. The bite registration tool set of claim 8, wherein the bite registration tools are present in one of four sizes S, M, L and XL.

10. The bite registration tool set of claim 8, wherein a bite fork with connection element is provided, which is fixed to the bite registration tool via a coding element.

11. The bite registration tool set of claim 8, wherein a milling block system comprising a milling block for an upper jaw and a lower jaw is provided, of which artificially formed teeth of a complete denture are present in the occlusal position, and the artificially formed teeth correspond to the tooth casts that are lined up in the occlusal position.

12. A method for bite registration using bite registration tools of claim 1, comprising:
a) taking an impression of a maxillary palate region for the creation of a virtual model, in order to join together congruent surfaces to form a virtual function model of the upper jaw;
b) making available a lower-jaw bite registration tool, which has a bite registration zone;
c) connecting the bite registration tools via a coding element; and
d) introducing an impression compound into the bite registration zone between the lower jaw and the lower-jaw bite registration tool in order to carry out the bite registration.

13. The method of claim 12, wherein an impression compound is introduced between the upper jaw and the upper-jaw bite registration tool.

14. The method of claim 12, wherein, with the release of the connection via the coding element of the bite registration tool, an esthetics check by the dentist and/or a positioning is carried out.

15. The method of claim 12, wherein the bite registration tools encoded via the coding element are positioned with impression compound in a dental scanner in order to generate a digital data record for the bite registration.

16. The method of claim 15, wherein, on the basis of the digital data record, the respective prosthesis base of a tooth set for upper jaw and lower jaw with artificially formed rows of teeth are machined in the occlusal position.
